(19) United States
(12) Patent Application Publication
(10) Pub. No.: US 2012/0084272 A1
(43) Pub. Date: Apr. 5, 2012

(54) FILE SYSTEM SUPPORT FOR INERT FILES

(75) Inventors: Luis Garcés-Erice, Zurich (CH); John G. Rooney, Zurich (CH)

(73) Assignee: International Business Machines Corporation, Armonk, NY (US)

(21) Appl. No.: 13/249,276

(22) Filed: Sep. 30, 2011

(30) Foreign Application Priority Data
Oct. 4, 2010 (EP) 10186436.1

(51) Int. Cl. G06F 7/00; G06F 17/00

(52) U.S. Cl. 707/698; 707/E17.01

(57) ABSTRACT

A method for storing a file on a data storage device. The method includes: storing the file in one of a first and a second file system; calculating a hash value; and storing the hash value on a storage device if it is stored in the second file system. A data processing system includes a first file system and a second file system wherein the data processing system calculates and stores a hash value when the file is stored in the second file system. A method for reading a file from a file system including: receiving a read command; reading a first hash value from a storage device; reading the file from the storage device; calculating a second hash value; returning the file when the first hash value equals the second hash value and returning an error when it does not equal the second hash value.

### CROSS REFERENCE TO RELATED APPLICATION

This application claims priority under 35 U.S.C. 119 from European Application 10186436.1, filed Oct. 4, 2010, the entire contents of which are incorporated herein by reference.

### BACKGROUND OF THE INVENTION

1. Technical Field

The present invention relates to a method for storing a file on a data storage device. The invention further relates to a data processing system. The invention further relates to a method for reading a file from a file system.

2. Description of the Related Art

Using file systems on data storage devices such as hard disks or CD-ROMs is known in the state of the art. The file system serves as a method of storing and organizing computer files and their data on the storage device. Examples of existing widely used file systems such are FAT32, NTFS, EXT3 and support many file types. A file is simply an abstraction of a set of related blocks stored on the disk. Keeping the file system independent of the actual content allows it to be generic, meaning that the same file system can store arbitrary content.

File based storage systems store the contents of a disk on a remote storage as a backup in order to be able to restore the contents of the disk after a data loss event. A data loss event may for example happen if the disk gets stolen, lost or damaged, or if a user unintentionally deletes part(s) of the disk. File based storage systems typically traverse the file system looking for files that have been modified since the previous backup procedure and store the new contents of the respective files on the remote storage. Usually, only the last version of each file is kept on the remote storage. In each backup run the latest version overwrites the previous version of the respective file. Consequently, recovering a version of a file older than the latest version is generally not possible.

A file system can become inconsistent due to damage to the disk, power outages preventing the completion of a write procedure in progress, failures in the operating system causing the file system to crash before an important operation was completed, and the like.

A typical file system inconsistency would lead to a given block being assigned to two different files, or a given file being in two different directories.

File based storage systems typically do not ensure the consistency of the file systems that they backup. This means that an inconsistent file may get stored and hence overwrite the previous consistent version.

### SUMMARY OF THE INVENTION

To overcome these deficiencies, the present invention provides a method for storing a file on a data storage device, including: storing the file in one of a first file system and a second file system; and calculating a hash value and storing the hash value on a storage device, wherein the file is stored in the second file system.

According to another aspect, the present invention provides a data processing system, including a first file system and a second file system provided to an application software for storing a file; wherein the data processing system calculates and stores a hash value when the file is stored in the second file system.

According to yet another aspect, the present invention provides a method for reading a file from a file system, including: receiving a read command; reading a first hash value from a storage device; reading the file from the storage device; calculating a second hash value; returning the file when the first hash value equals the second hash value; and returning an error when the first hash value does not equal the second hash value.

### BRIEF DESCRIPTION OF THE SEVERAL VIEWS OF THE DRAWINGS

Reference will now be made, by way of example, to the accompanying drawings, in which:

FIG. 1 schematically depicts a data processing system with two storage devices and four file systems;

FIG. 2 schematically depicts the data processing system with one of the file systems accessed in a conventional manner;

FIG. 3 schematically depicts an alternative data processing system that provides two file systems;

FIG. 4 schematically depicts a mapping between files and hash values;

FIG. 5 shows a schematic flow diagram of a method for storing an inert file;

FIG. 6 shows a schematic flow diagram of a method for reading an inert file.

### DETAILED DESCRIPTION OF THE PREFERRED EMBODIMENTS

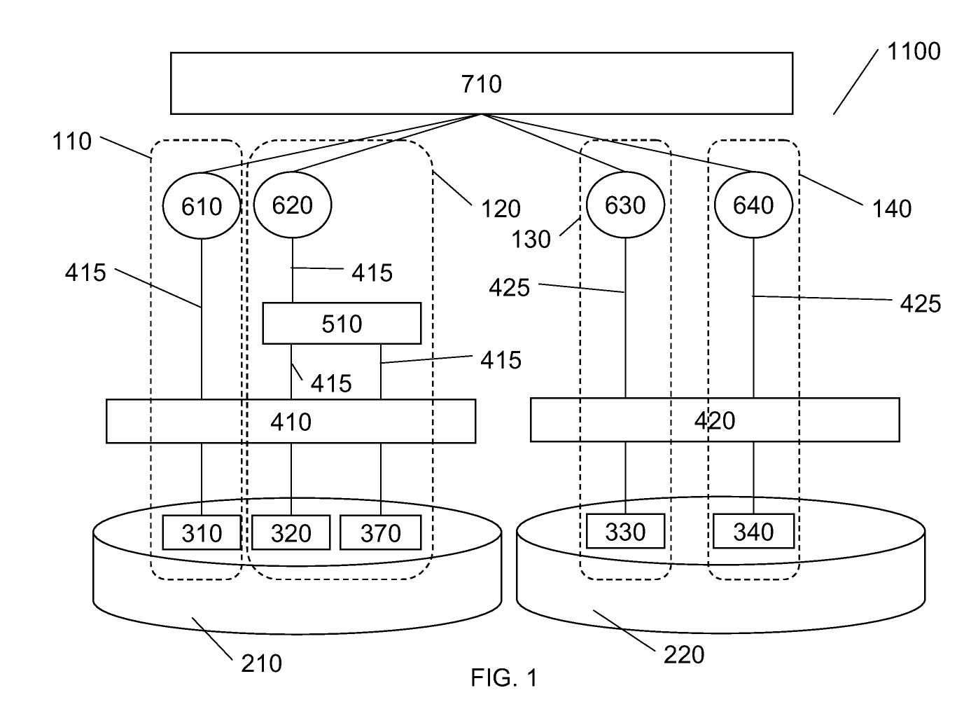

FIG. 1 schematically depicts a first data processing system 1100. The first data processing system 1100 may for example be a personal computer running a WINDOWS® operating system, a LINUX® operating system, an OSX® operating system or another operating system.

The first data processing system 1100 includes a first storage device 210 and a second storage device 220. The first storage device 210 and the second storage device 220 may for example be hard disk drives or partitions on a hard disk drive. In the case that the first storage device 210 and the second storage device 220 are hard disk drives, each of the hard disk drives may include one or more partitions.

The first data processing system 1100 includes a first file system 110, a second file system 120, a third file system 130 and a fourth file system 140. The file systems 110, 120, 130, and 140 are provided by the operating system running on the first data processing system 1100 to user applications running on the first data processing system 1100 and to human users of the first data processing system 1100. In the example of FIG. 1, the first data processing system 1100 is running a first user application 710. The first user application 710 may for example be a word processor, a database management system or an image organizer, viewer software, and the like.

Each of the file systems 110, 120,130, and 140 is presented to a user of the first data processing system 1100 and to the first user application 710 running on the first data processing system 1100 as a file system identifier. The first file system 110 is represented by a first file system identifier 610; the second file system 120 is represented by a second file system identifier 620; the third file system 130 is represented by a third file system identifier 630; and the fourth file system 140 is represented by a fourth file system identifier 640. The file system identifiers 610, 620, 630, and 640 may for example be drive letters or mount points, depending on the operating system running on the first data processing system 1100. The first file system identifier 610 may for example be a drive letter C. The second file system identifier 620 may for example be a drive letter D. The third file system identifier 530 may for example be a drive letter E. The fourth file system identifier 640 may for example be a drive letter F. The first user application 710 may address one of the file systems 110, 120, 130, 140 by the respective file system identifier 610, 620, 630, and 640.

The third file system 130 and the fourth file system 140 are both managed by a second file system driver 420. The second file system driver 420 may for example be a file system driver for a FAT32 file system. The second file system driver 420 provides a second API (application programming interface) 425 to the first user application 710 for accessing the third file system 130 and the fourth file system 140. Since both the third file system 130 and the fourth file system 140 are handled by the second file system driver 420, the second API 425 can be used by the first user application 710 for using the third file system 130 and for using the fourth file system 140. If the first user application 710 decides to store a file in the third file system 130 by addressing the third file system identifier 630 and using the second API 425, the second file system driver 420 stores the file in the third stored data blocks 330 on the second storage device 220. If the first user application 710 decides to store a file in the fourth file system 140 by addressing the fourth file system identifier 640 and using the second API 425, the second file system driver 420 stores the file in the fourth stored data blocks 340 on the second storage device 220. The third stored data blocks 330 and the fourth stored data blocks 340 can be saved in a shared partition on the second storage device 220 or in distinct partitions on the second storage device 220.

The first file system 110 is managed by a first file system driver 410. The first file system driver may for example be an NTFS file system driver. The first file system driver 410 offers a first API 415 to the first user application 710 for using the first file system 110. If the first user application 710 decides to store a file in the first file system 110 by addressing the first file system identifier 610 and using the first API 415, the first file system driver 410 stores the file in first stored data blocks 310 on the first storage device 210.

The second file system 120 is managed by the first file system driver 410 and by a first virtual file system driver 510. The first virtual file system driver 510 may for example be implemented as a filter driver on a WINDOWS® operating system. The first virtual file system driver 510 internally uses the first file system driver 410 by means of the first API 415. Furthermore, the first virtual file system driver 510 offers the first API 415 to the first user application 710. Consequently, the first user application 710 may access the second file system 120 by using the same first API 415 as is used for accessing the first file system 110. If the first user application 710 decides to store a file in the second file system 120 by addressing the second file system identifier 620 and using the first API 415, the first virtual file system driver 510 stores the file in the second stored data blocks 320 on the first storage device 210 by using the first file system driver 410. Additionally, the first virtual file system driver 510 calculates a hash value from the contents of the file and stores the hash value and a data item associating the file with the hash value in seventh stored data blocks 370 on the first storage device 210 by using the first file system driver 410. Calculating and storing the hash value happens transparently to the first user application 710. This means that the first user application 710 can be unaware that a hash value has been calculated and stored in the seventh stored data blocks 370.

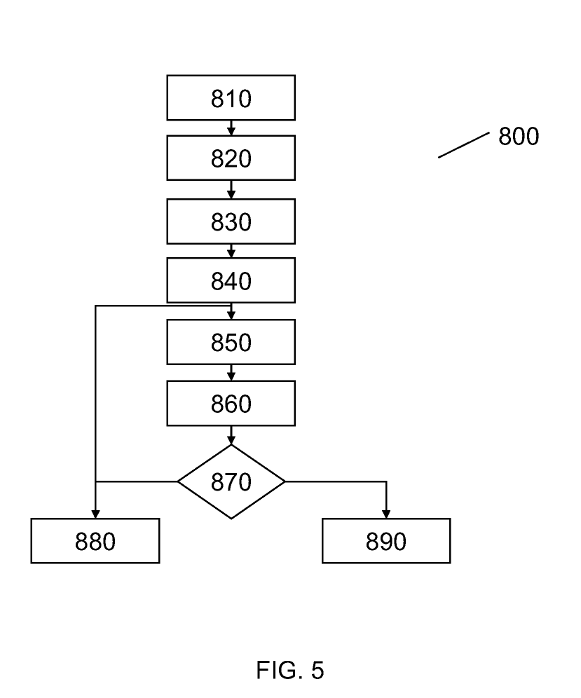

FIG. 5 shows a schematic flow diagram of a method 800 performed by the first virtual file system driver 510 upon storing a file in the second file system 120. In a first step 810 the first virtual file system driver 510 receives a command to store a file by the first user application 710. In a second step 820 the first virtual file system driver 510 calculates a first hash value from the contents of the file that is to be stored in the second file system 120. In a third step 830 the first virtual file system driver 510 stores the file in the second stored data blocks 320 on the first storage device 210 by using the first file system driver 410. In a fourth step 840 the first virtual file system driver 510 stores the calculated first hash value and an association between the file and the first hash value in the seventh stored data blocks 370 on the first storage device 210 by employing the first file system driver 410. After the fourth step 840 the first virtual file system driver 510 can complete the method 800. In another embodiment, however, the method 800 continues with a fifth step 850 in which the first virtual file system driver 510 reads the file that has just been stored back from the second stored data blocks 320 by employing the first file system driver 410. In a following sixth step 860 the first file system driver 510 then calculates a second hash value from the contents of the file that has been read in the previous step. After that, the first file system driver 510 compares the first hash value with the second hash value in a seventh step 870. If the first hash value equals the second hash value the first file system driver 510 can then complete the method 800 in an eighth step 880 and return a result that indicates successful storage of the file in the second file system 120. If the comparison between the first hash value and the second hash value, however, shows that both hash values do not match, the first virtual file system driver 510 detects a failed storage operation in a ninth step 890 and may either return an error or retry storing the file by returning to the second step 820.

A hash value is calculated from the contents of a file by means of a cryptographic hash function such as MD5, SHA1, and the like. The hash value serves as a digest that usually uniquely identifies the file content. Modifying the file content and recalculating the hash value will result in a modified hash value. It is very unlikely that a file will have the same hash value after a modification of the file. The hash value can therefore serve as a checksum for verifying the file. The fifth, sixth and seventh steps 850, 860, and 870 of schematically depicted method 800 and FIG. 5 therefore serve to validate if the file has been correctly stored in the second stored data blocks 320. If the data saved in the second stored data blocks 320 does not match the original file, the second hash value will not match the first hash value.

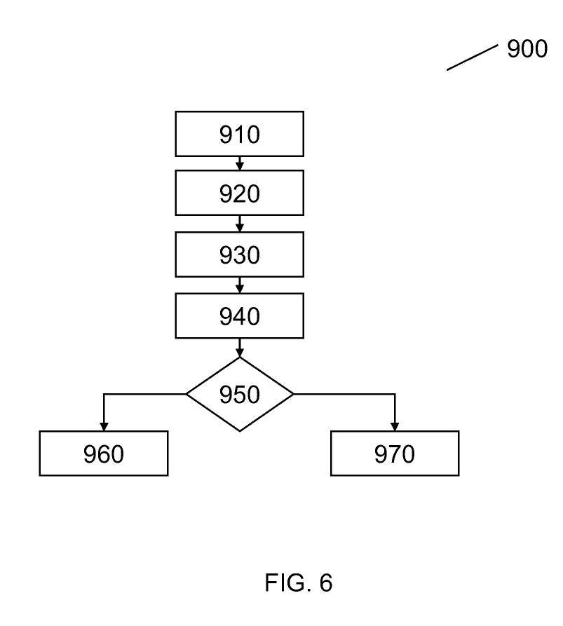

FIG. 6 shows a schematic flow diagram of a method 900 for reading a file from the second file system 120. The method 900 is performed by the first virtual file system driver 510. In a first step 910 the first virtual file system driver 510 receives a read command to read a file from the second file system 120 by the first user application 710. In a second step 920 the first virtual file system driver 510 reads a first hash value associated with the file to be read from the seventh stored data blocks 370. In order to read the hash value the first virtual file system driver 510 makes use of the first file system driver 510. In a third step 930 the first virtual file system driver 510 reads the file from the second stored data blocks 320 on the first storage device 210 by employing the first file system driver 410. In a fourth step 940 the first virtual file system driver 510 calculates a second hash value from the contents of the file that has been read in the previous step 930. In a fifth step 950 the first virtual file system driver 510 compares the first hash value with the second hash value. If the two hash values are equal, the first virtual file system driver 510 returns the file in a sixth step 960. If the hash values are not equal the first virtual file system driver 510 returns a result to the first user application 710 that indicates an error in a seventh step 970.

The method 900 depicted in FIG. 6 allows for the determination of whether the file to be read has been corrupted. If the first user application 710 is a file based storage system, the file based storage system can then be informed that the file has been corrupted and should not be used to overwrite a previous intact version of the same file. This guarantees that the backup will always keep an intact version of the file.

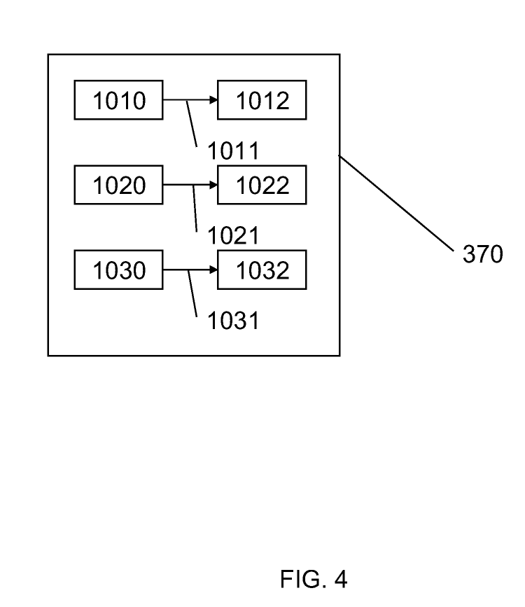

FIG. 4 shows a detailed schematic view of the data stored in the seventh stored data blocks 370. The seventh stored data blocks 370 contain hash values for files stored in the second file system 120 as well as associations between the files and their respective hash values. In the example of FIG. 4 such associations are shown for three files stored in the second file system 120. The seventh stored data blocks 370 include a first pointer 1010 to a first file, a second pointer 1020 to a second file and a third pointer 1030 to a third file all stored in the second file system 120. The seventh stored data blocks 370 further include a first hash value 1012 calculated from the content of the first file, a second hash value 1022 calculated from the contents of the second file and a third hash value 1032 calculated from the contents of the third file. The seventh stored data blocks 370 furthermore include information 1011, 1021, and 1031 that associates the hash value 1012, 1022, and 1032 with the file and is stored on a storage device 210 and 250. Specifically, the seventh stored data blocks 370 furthermore include a first association 1011 that associates the first pointer 1010 with the first hash value 1012, a second association 1021 that associates the second pointer 1020 with the second hash value 1022 and a third association 1031 that associates the third pointer 1030 with the third hash value 1032. Consequently, the seventh stored data blocks 370 allow retrieval of a hash value for each file stored in the second file system 120.

The method 800 for storing a file in the second file system 120 depicted in FIG. 5 and the method 900 for reading a file from the second file system 120 depicted in FIG. 6 use more system resources than methods for storing files in the first file system 110 and for reading files from the first file system 110 that do not need to calculate and compare hash values. Consequently, access to the second file system 120 is slower than access to the first file system 110. On the other hand, as described above, the second file system 120 managed by the first virtual file system driver 510 provides means to determine whether a file has been corrupted. It is therefore preferable to store files on the second file system 120 that are expected to be never or only very rarely modified. Such files can be termed inert files or immutable files. The first file system 110, on the other hand, is preferentially used for files that change regularly. Such files can be referred to as mutable files. An example of an inert file that rarely ever changes is for example a digital photo that has been copied from a digital camera. An example of a mutable file that is expected to change regularly is a log file that records actions performed by a software.

Advantageously, the first data processing system 1100 shown in FIG. 1 allows the first user application 710 to decide which of the files handled by the first user application 710 should be treated as mutable files and which files should be treated as inert files. The first user application 710 simply stores all files that are expected to change regularly on the first file system 110, the third file system 130, or the fourth file system 140, and stores all files that are expected to never change or only change rarely on the second file system 120.

It is also possible that the first user application 710 leaves it to a user of the first user application 710 to decide whether a file should be treated as a mutable file and be stored in one of the first file system 110, the third file system 130, and the fourth 140, or whether the file should be treated as an inert file and be stored on the second file system 120. The first user application 710 may let the user decide this by prompting the user to pick a file system identifier for storing the file. If the user chooses the first file system identifier 610, the file will be treated as a mutable file. If the user chooses the second file system identifier 620, the file will be treated as an inert file. To this end, the first user application 710 can be completely unaware of the extended functionality of the second file system 120.

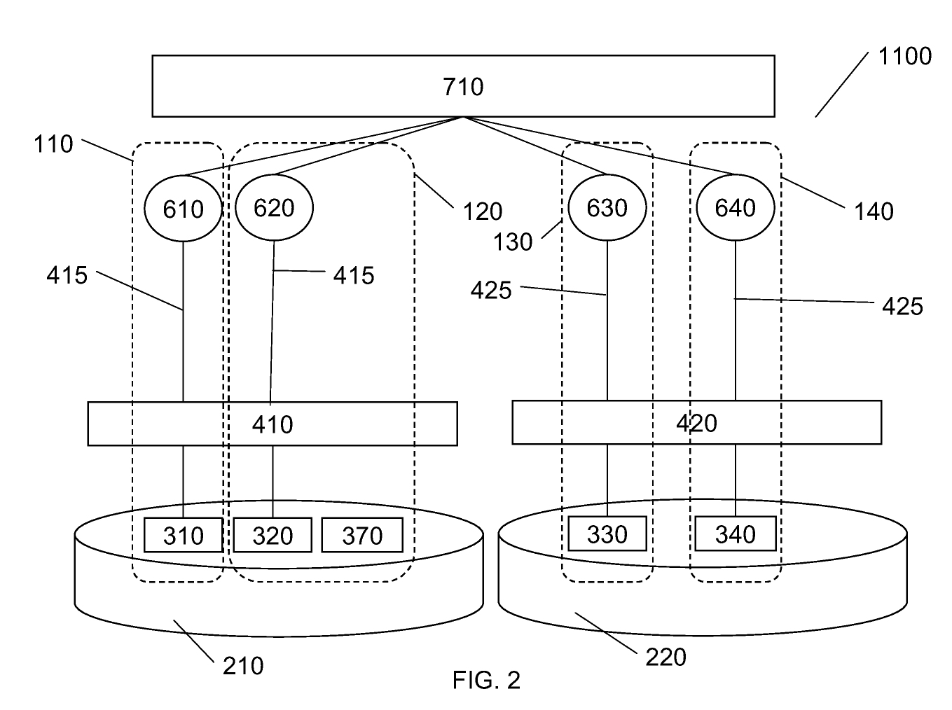

Since the second file system 120 is managed by the first virtual file system driver 510 which internally uses the first file system driver 410 to store files in the second stored data blocks 320 on the first storage device 210 it is possible to access the second stored data blocks 320 without using the first virtual file system driver 510. This situation is schematically depicted in FIG. 2. FIG. 2 shows the first data processing system 1100 of FIG. 1 in a mode of operation in which the second file system 120 is not managed by the first virtual file system driver 510 but only by the first file system driver 410. Since the first virtual file system driver 510 has offered the first API 415 to the first user application 710 in the mode shown in FIG. 1 and since the first file system driver 410 also offers the same first API 415 to the first user application 710 in the mode shown in FIG. 2, the second file system 120 appears the same to the first user application 710 in both the situations of FIG. 1 and FIG. 2. Since the first file system driver 410 does not calculate hash values while reading and writing files, the mode of operation shown in FIG. 2 allows for a faster access to the data stored in the second file system 120. Consequently, the mode of operation depicted in FIG. 2 can be used for efficient read-access to the second file system 120, for recovery or for other time-critical operations.

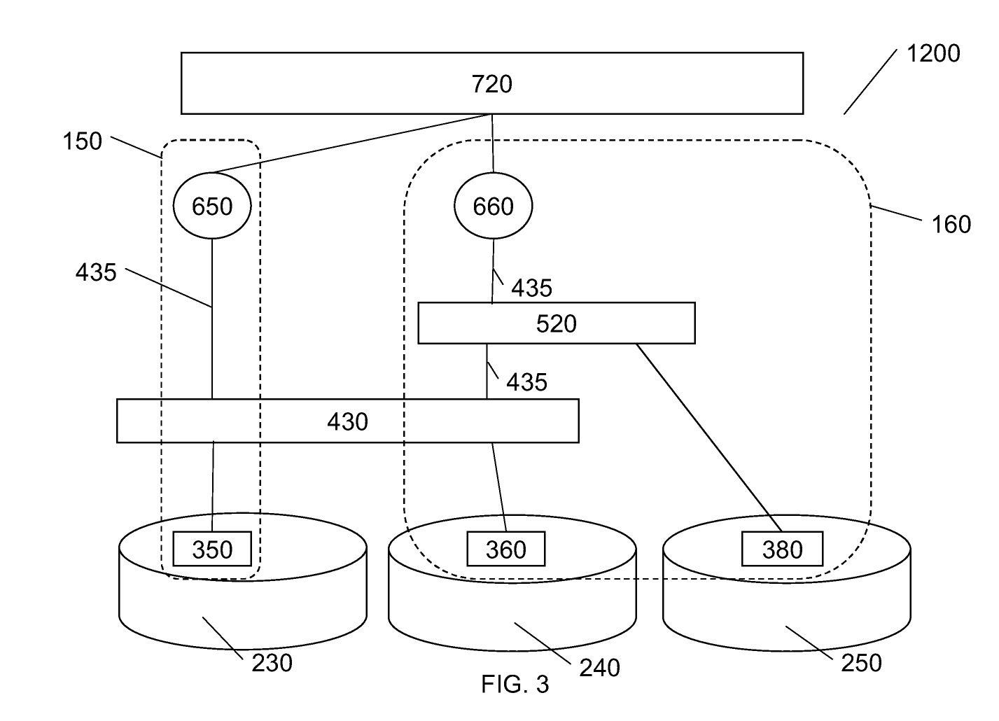

FIG. 3 schematically depicts a second data processing system 1200 according to a second embodiment. The second data processing system 1200 may for example be a personal computer running a LINUX® operating system. The second data processing system 1200 includes a third storage device 230, a fourth storage device 240 and a fifth storage device 250. The second data processing system 1200 runs a second user application 720. The second data processing system 1200 provides a fifth file system 150 and a sixth file system 160. The fifth file system 150 is presented to the second user application 720 by a fifth file system identifier 650. The sixth file system 160 is presented to the second user application 720 by a sixth file system identifier 660. The fifth file system identifier 650 and the sixth file system identifier 660 may for example be mount points. The fifth file system identifier 650 may for example be the mount point /var/. The sixth file system identifier 660 may for example be the mount point /home/user/photos/.

The fifth file system 150 is managed by a third file system driver 430. The fifth file system driver 430 may for example be an EXT3 file system driver. The third file system driver 430 offers a third API 435 to the second user application 720. If the second user application 720 decides to store a file in the fifth file system 150 by choosing the fifth file system identifier 650 and using the third API 435 the third file system driver 430 stores the file in fifth stored data blocks 350 on the third storage device 230.

The sixth file system 160 is managed by a second virtual file system driver 520. The second virtual file system driver 520 can for example be a user space file system driver implemented using the Filesystem in Userspace (FUSE) system. The second virtual file system driver 520 internally uses the third file system driver 430. To this end, the second virtual file system driver 520 uses the third API 435. The second virtual file system driver 520 furthermore provides the same third API 435 to the second user application 720. The second virtual file system driver 520 performs the method 800 for storing a file in the sixth file system 160 and the method 900 for reading a file from the sixth file system 160. If the second user application 720 decides to store a file in the sixth file system 160 by choosing the sixth file system identifier 660 and using the third API 435, the second virtual file system driver 520 instructs the third file system driver 430 to store the file in the sixth stored data blocks 360 on the fourth storage device 240. The second virtual file system driver 520 furthermore calculates a hash value from the contents of the file and stores the calculated hash value and an association between the file and the hash value in eight stored data blocks 380 on the fifth storage device 250. In the embodiment shown in FIG. 3, the second virtual file system driver 520 stores the hash value and the association between the file and the hash value without employing the third file system driver 430. The second virtual file system driver 520 can, however, employ the third file system driver 430 also for storing the hash value and the association between the file and the hash value in the eight stored data blocks 380 on the fifth storage device 250.

The second data processing system 1200 shown in FIG. 3 may also be operated in a mode in which the sixth file system 160 is only managed by the third files system driver 430 without the second virtual file system driver 520. This mode of operation may again be used for time-critical access to the sixth file system 160.

In the embodiment of the first data processing system 1100 shown in FIG. 1, the third file system 130 and the fourth file system 140 can be omitted. In this case, the second storage device 220 can be omitted. Alternatively, the first file system 110 and the fourth file system 140 can be omitted such that the first data processing system 1100 only includes the second file system 120 and the third file system 130. In this case, the second file system 120 is accessed using the first API 415 while the third file system 130 is accessed using the second API 425.

The seventh stored data blocks 370 are preferably stored in a distinct partition of the first storage device 210. Alternatively, the seventh stored data blocks 370 are stored on a distinct hard disk. The seventh stored data blocks 370 are preferred to be invisible to the first user application 710 and to a user of the first data processing system 1100. To this end, the seventh stored data blocks 370 may for example be stored on a hidden partition. This applies equally to the eight stored data blocks 330 of the second data processing system 1200 depicted in FIG. 3.

In the embodiments shown in FIGS. 1 to 3 the virtual file system drivers 510, 520 calculate one hash value per file stored in the second file system 120 and the sixth file system 160. In alternative embodiments, the virtual file system drivers 510 and 520 might calculate one hash value per file system block stored in the second file system 120 or the sixth file system 160. This increases the granularity. In case a file becomes corrupted, the increased granularity allows for determination of which part of the file has been corrupted, thereby allowing eventual recovery of intact parts of the otherwise corrupted file. In a further embodiment, the virtual file system drivers 510 and 520 calculate one hash value per set of files stored in the second file system 120 or the sixth file system 160. This reduces the amount of hash values that have to be calculated and stored in the seventh stored data blocks 370 or the eight stored data blocks 380, thereby reducing the overhead caused by the virtual file system drivers 510, 520.

The data processing systems 1100 and 1200 can be part of a storage management system. The storage management system may also be called a storage system or a backup system. The storage management system may include a plurality of nodes. Some of these nodes can be referred to as client nodes. Client nodes may for example be desktop computers. The data processing systems 1100 and 1200 can be client nodes of the storage management system. Client nodes are used for creating and manipulating data. Such data may for example include text documents, digital artwork or database contents. The data can be stored locally in storage provided by the client nodes.

Other nodes of the storage management system can be referred to as server nodes. Server nodes may for example be computers located in a central data center. Server nodes provide storage for storing backups of data that is created and stored on client nodes. In case the storage of one of the client nodes is damaged or corrupted, the data that was stored in the now damaged local storage can be recovered from the backup stored on a server node.

Client nodes may each run a backup program that regularly copies all files from the local storage to the storage on a server node that have been modified since the previous backup procedure. Usually, only the last version of each file is kept on the remote storage. Each run of the backup program consequently overwrites the previous versions of the respective files. Recovering a version of a file older than the latest version is generally not possible.

Advantageously the method 900 depicted in FIG. 6 allows the data processing systems 1100 and 1200 to determine if an inert file has been corrupted. The backup program can then be informed that the modified file should not be used to overwrite a previous intact version of the same file. This guarantees that the backup stored on a server node will always keep an intact version of the file.

What is claimed is:

1. A method for storing a file on a data storage device, comprising:
storing said file in one of a first file system and a second file system; and
calculating a hash value and storing said hash value on a storage device, wherein said file is stored in said second file system.

2. The method according to claim 1, wherein said first file system and said second file system are addressed by distinct file system identifiers.

3. The method according to claim 1,
wherein an application software initiates storing of said file; and
wherein said application software determines the storage location of said file as selected from the group consisting of said first file system and said second file system.

4. The method according to claim 3, wherein said application software provides a user interface to a user to receive user input for determining the storage location of said file as selected from the group consisting of said first file system and said second file system.

5. The method according to claim 3, wherein said application software determines, in dependence on a predefined characteristic of said file, the storage location of said file as selected from the group consisting of said first file system and said second file system.

6. The method according to claim 3, wherein said application software uses a same API for storing said file in said first file system and for storing said file in said second file system.

7. The method according to claim 1, wherein said hash value is calculated by a file system driver of said second file system.

8. The method according to claim 1, wherein one hash value per file is calculated.

9. The method according to claim 1, wherein one hash value per file system block is calculated.

10. The method according to claim 1, wherein one hash value is calculated for a set of files.

11. The method according to claim 1, wherein said hash value is calculated using a cryptographic hash function.

12. The method according to claim 1, wherein said hash value is stored in a distinct partition of a hard disk drive.

13. The method according to claim 1, wherein information that associates said hash value with said file is stored on a storage device.

14. The method according to claim 1, wherein said first file system and said second file system use the same data format for storing data on a storage device.

15. The method according to claim 1, wherein a file system driver of said second file system uses a file system driver of said first file system.

16. The method according to claim 15, wherein said file system driver of said second file system runs in user space.

17. The method according to claim 15, wherein said file system driver of said second file system is a filter driver.

18. A data processing system, comprising:
a first file system and a second file system provided to an application software for storing a file;
wherein said data processing system calculates and stores a hash value when said file is stored in said second file system.

19. The data processing system according to claim 18, wherein a same API is provided to said application software for storing said file in said first file system and for storing said file in said second file system.

20. A method for reading a file from a file system, comprising:
receiving a read command;
reading a first hash value from a storage device;
reading said file from said storage device;
calculating a second hash value;
returning said file when said first hash value equals said second hash value; and
returning an error when said first hash value does not equal said second hash value.

21. The method according to claim 20, further comprising a file system driver for reading said file from said file system.
